(19) United States
(12) Patent Application Publication
(10) Pub. No.: US 2026/0010306 A1
(43) Pub. Date: Jan. 8, 2026

(54) METHOD AND DEVICE WITH PAGE LIST MANAGEMENT

(71) Applicant: Samsung Electronics Co., Ltd., Suwon-si (KR)

(72) Inventors: Liyuan ZHANG, Xi’an (CN); Deok-Jae OH, Suwon-si (KR); Yuehua DAI, Xi’an (CN); Mao CHEN, Xi’an (CN); Xiao LAN, Xi’an (CN)

(73) Assignee: Samsung Electronics Co., Ltd., Suwon-si (KR)

(21) Appl. No.: 19/258,679

(22) Filed: Jul. 2, 2025

(30) Foreign Application Priority Data
Jul. 2, 2024 (CN) 202410878065.X
Dec. 19, 2024 (KR) 10-2024-0191252

(51) Int. Cl. G06F 3/06

(52) U.S. Cl. CPC G06F 3/0638; G06F 3/0622; G06F 3/0679

(57) ABSTRACT

A method includes obtaining statistical information about page access by scanning a page table entry related to a page table, classifying a page in the page table entry as a hot page or a cold page based on the statistical information, generating a page list comprising the classified hot page or the classified cold page, and transmitting the page list to a host device, wherein the page list is used to adjust a least recently used (LRU) list.

### CROSS-REFERENCE TO RELATED APPLICATIONS

This application claims the benefit under 35 USC § 119(a) of Chinese Patent Application No. 202410878065.X filed on Jul. 2, 2024 in the China National Intellectual Property Administration, and Korean Patent Application No. 10-2024-0191252 filed on Dec. 19, 2024 in the Korean Intellectual Property Office, the entire disclosures of which are incorporated herein by reference for all purposes.

### BACKGROUND

### 1. Field

The following description relates to a method and device with page list management.

### 2. Description of Related Art

A compute express link (CXL) technology may implement high-performance computing by maintaining the memory consistency between a central processing unit (CPU) memory and a device memory and sharing resources. In addition, the CXL technology may be used because the CXL technique may decrease the complexity of a software stack and the cost of the overall system.

A CXL-based memory layering technology may be related to a least recently used (LRU) algorithm that replaces or removes recently unused data. The LRU algorithm may be a core memory management algorithm for determining whether to keep a memory page in a main memory or retrieve the memory page, in a Linux kernel.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a method includes obtaining statistical information about page access by scanning a page table entry related to a page table, classifying a page in the page table entry as a hot page or a cold page based on the statistical information, generating a page list comprising the classified hot page or the classified cold page, and transmitting the page list to a host device, wherein the page list is used to adjust a least recently used (LRU) list.

The obtaining of the statistical information may include receiving a scan frequency related to the page access from the host device, and obtaining an access count of the page by monitoring an access bit of the page based on the scan frequency, and the access count may be at least a portion of the statistical information.

The classifying of the page as the hot page or the cold page may include obtaining a threshold value to classify the page as either one of the hot page and the cold page, and classifying the page as the hot page or the cold page based on the access count of the page and the threshold value.

The classifying of the page as the hot page or the cold page may include classifying a page of which an access count of the page is greater than or equal to the threshold value as the hot page and classifying a page of which an access count of the page is less than the threshold value as the cold page.

The generating of the page list may include generating an initial page list in which the classified hot page or the classified cold page is not sorted, receiving, from the host device, a sort frequency indicating how frequently the initial page list is to be sorted according to an LRU algorithm, and generating the page list in a sorted state by sorting the initial page list based on the sort frequency.

The generating of the page list in the sorted state by sorting the initial page list may include generating the page list in the sorted state by sorting the classified hot page or the classified cold page according to a size of the access count of the page.

The transmitting of the page list to the host device may include extracting a hot page of which an access count is greater than or equal to a threshold value from one or more hot pages included in the generated page list and a cold page of which an access count is less than the threshold value from one or more cold pages included in the generated page list, and transmitting the page list comprising the extracted hot page and the extracted cold page to the host device.

The method may include receiving, from a compute express link (CXL) device, the page list, and adjusting the LRU list based on the page list.

In one or more general aspects, a non-transitory computer-readable storage medium may store code that, when executed by one or more processors, configure the one or more processors to perform any one, any combination, or all of operations and/or methods disclosed herein.

In one or more general aspects, a method includes receiving, from a compute express link (CXL) device, a page list in which a page in a page table entry is classified as a hot page or a cold page, and adjusting a least recently used (LRU) list based on the page list, wherein the page list is generated based on statistical information about page access obtained by scanning the page table entry related to a page table.

The method may include transmitting a scan frequency related to the page access to the CXL device.

The statistical information may include an access count of the page, and the access count of the page may be obtained by monitoring an access bit of the page based on the scan frequency by the CXL device.

The method may include transmitting, to the CXL device, a sort frequency indicating how frequently a page list is sorted according to an LRU algorithm, wherein the page list may be generated by sorting an initial page list comprising the classified hot page or the classified cold page in an unsorted state, based on the sort frequency.

The page list may include a hot page of which an access count of the page is greater than or equal to a threshold value and a cold page of which an access count of the page is less than the threshold value.

The adjusting of the LRU list may include arranging the hot page of which the access count of the page is greater than or equal to the threshold value on a head of an active LRU list in the LRU list, and arranging the cold page of which the access count of the page is less than the threshold value on a tail of an inactive LRU list in the LRU list.

In one or more general aspects, a device for managing a page list includes a compute express link (CXL) device comprising a CXL processor and a CXL memory, and a host device comprising a host processor and a host memory, wherein the CXL device may be configured to obtain statistical information about page access by scanning a page table entry related to a page table, classify a page in the page table entry as a hot page or a cold page based on the statistical information, generate a page list comprising the classified hot page or the classified cold page, and transmit the page list to a host device, and wherein the page list is used to adjust a least recently used (LRU) list.

The CXL device may be configured to receive a scan frequency related to the page access from the host device, and obtain an access count of the page by monitoring an access bit of the page based on the scan frequency, and the access count may be at least a portion of the statistical information.

The CXL device may be configured to obtain a threshold value to classify the page as either one of the hot page and the cold page, and classify the page as the hot page or the cold page based on the access count of the page and the threshold value.

The CXL device may be configured to generate an initial page list in which the classified hot page or the classified cold page is not sorted, receive, from the host device, a sort frequency indicating how frequently the initial page list is to be sorted according to an LRU algorithm, and generate the page list in a sorted state by sorting the initial page list based on the sort frequency.

The host device may be configured to receive the page list in which a page in the page table entry is classified as the hot page or the cold page from the CXL device, and adjust the LRU list based on the page list.

The host device may be configured to arrange a hot page of which an access count of the page is greater than or equal to a threshold value on a head of an active LRU list in the LRU list, and arrange a cold page of which an access count of the page is less than the second value on a tail of an inactive LRU list in the LRU list.

Other features and aspects will be apparent from the following detailed description, the drawings, and the claims.

### BRIEF DESCRIPTION OF THE DRAWINGS

FIG. 1 is a flowchart of a method of managing a page list executed by a compute express link (CXL) device according to one or more embodiments.

FIG. 2 is a flowchart of a method of managing a page list executed by a host device according to one or more embodiments.

FIG. 3 is a diagram illustrating an architecture of a method of managing a page list according to one or more embodiments.

FIG. 4 is a diagram illustrating a framework between a CXL device and a host device according to one or more embodiments.

FIG. 5 is a block diagram illustrating a CXL device included in a page list management device according to one or more embodiments.

FIG. 6 is a block diagram illustrating a host device included in a page list management device according to one or more embodiments.

FIG. 7 is a block diagram illustrating an electronic device according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used in connection with embodiments of the disclosure, the term “module” may include hardware (e.g., hardware implementing software, or firmware) and may interchangeably be used with other terms, for example, “part” or “circuitry.” A module may be a single integral component, or a minimum unit or part thereof, adapted to perform one or more functions. For example, according to one embodiment, the module may be implemented in a form of an application-specific integrated circuit (ASIC).

The term “-unit” refers to a hardware component, such as hardware implementing software, a field programmable gate array (FPGA), and/or an ASIC, and the “-unit” plays specific roles. The functionality provided within the components and the “-units” may be combined into a smaller number of components and the “-units” or may be further divided into additional components and “-units”. In addition, the components and the “-units” may be included in, and/or implemented to execute, one or more CPUs in the device or a secure multimedia card. In addition, the “-unit” may include one or more processors.

A Linux kernel may use a least recently used (LRU) algorithm that replaces and/or removes recently unused data. The LRU algorithm may be a core part for determining whether to keep a memory page in a main memory or retrieve the memory page, in a Linux kernel. For example, pages in a system memory may be divided and/or classified into either of two types, an anonymous page and a file-backed page, and each type of the pages may be classified as either of an LRU list and a linked list. The “page” described herein may refer to a page, which is a basic unit used for memory management, and may be used interchangeably with a memory page.

A typical LRU mechanism using the LRU algorithm may have two problems. The first problem of the typical LRU mechanism is that a page may not be accurately classified into either one of a hot page and a cold page because the page is classified only based on whether the page includes an active list or an inactive list and pages in a list are not adjusted in a strict order. The active list may typically include a page that is relatively frequently used and is currently used by the system and the inactive list may include a page that is relatively less frequently used and is subject to priority retrieval. The second problem of the typical LRU mechanism is that when monitoring whether the page is accessed, reverse mapping may need to be performed, but the task of reverse mapping may consume high cost and a lot of CPU resources.

A multiple-generational LRU (MGLRU) mechanism may replace the typical LRU mechanism. The MGLRU mechanism may optimize page retrieval and may improve the system performance under a memory shortage state. For example, (1) the MGLRU may provide more detailed page classification by supporting various layers in each generation by expanding a second generation LRU structure (in other words, the active list and inactive list) to a fourth generation LRU structure; (2) The MGLRU may reduce page scan overhead by directly scanning a page table entry (PTE) instead of scanning a memory page of an LRU list and finding the PTE through reverse mapping and may provide better access locality; and (3) The MGLRU may additionally reduce scan overhead by skipping an idle process scan.

LRU list sorting based on data access monitoring (DAMON) may divide a memory address space of a process into multiple regions and may examine access information of a page by randomly sampling one or more pages in each region. Through this process, the page access information of the entire region may be efficiently updated. The DAMON-based LRU list sorting may improve the order of pages in an LRU list to a certain level by actively adjusting locations of hot pages and cold pages in an LRU list based on the access information of a page collected by DAMON.

In the above description related to LRU list sorting, the classification of hot pages and cold pages based on the LRU algorithm may depend on the PTE scan. A frequent PTE scan may improve the accuracy of page access tracking but may cause high CPU overhead. As a scan interval increases, the CPU overhead may decrease but the accuracy of page access tracking may decrease. A typical technique related to the above LRU list sorting may not accurately distinguish a hot page from a cold page due to low CPU overhead and may not balance the CPU overhead and the accuracy of page access tracking for PTE scanning. In addition, as the memory capacity increases, the number of memory pages to be scanned and adjusted may increase, and thereby, the CPU overhead may increase. As the memory capacity increases, the CPU usage of the LRU algorithm may increase and the CPU overhead may also increase.

In contrast to the technical problems discussed above, the page list management method and device of one or more embodiments may provide a solution for improving the accuracy of the classification of hot pages and cold pages based on the LRU algorithm. The page list management method and device of one or more embodiments may accurately classify hot pages and cold pages with lower CPU overhead by executing frequent PTE scanning and page list sorting in the CXL device. The page list management method and device may collect detailed statistical information related to page access by adopting an access tracking module (e.g., an access tracking unit (ATU)) into the CXL device. The page list management method and device may sort an LRU list (or a page list) based on the statistical information related to page access collected by the ATU by adopting an LRU sorting module (e.g., an LRU sorting unit (LSU)) into the CXL device. The page list management method and device may perform LRU list adjustment by adopting an enhanced LRU agent (ELRU agent) into the host device. The page list management method and device of one or more embodiments may allow the Linux kernel to make a more accurate page retrieval decision by increasing the accuracy of the Linux kernel as the accuracy of page classification increases and may allow a system for performing memory layering based on a Linux LRU mechanism to make a more accurate page arrangement decision.

Hereinafter, embodiments related to the page list management method and device will be described in detail with reference to the accompanying drawings. When describing the embodiments with reference to the accompanying drawings, like reference numerals refer to like elements and a repeated description related thereto will be omitted.

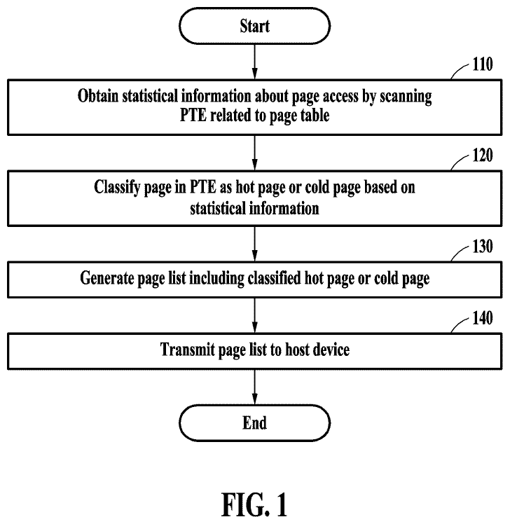

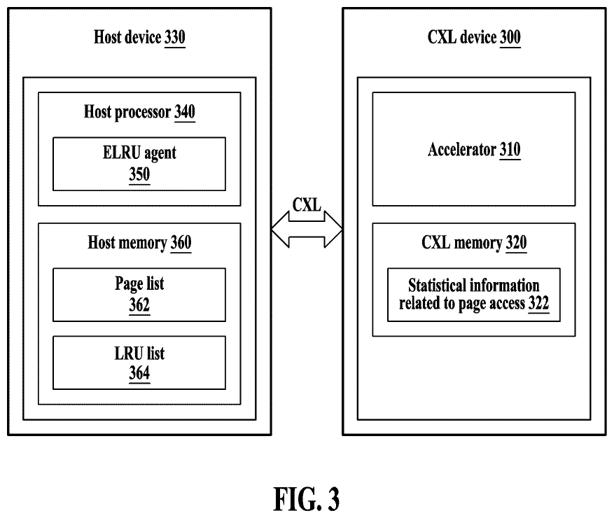

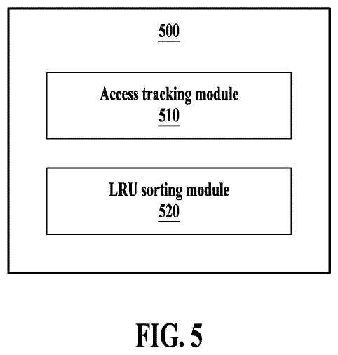

FIG. 1 is a flowchart of a method of managing a page list executed by a compute express link (CXL) device according to one or more embodiments. Operations of the method of managing a page list may be performed by an electronic device such as a CXL device (e.g., a CXL device 300 of FIG. 3 and/or a CXL device 500 of FIG. 5) described herein. Operations 110 to 140 to be described hereinafter may be performed sequentially in the order and manner as shown and described below with reference to FIG. 1, but two or more of the operations may be performed simultaneously or in parallel, the order of one or more of the operations may be changed, one or more of the operations may be omitted, and other operations may be additionally performed without departing from the spirit and scope of the example embodiments described herein.

Referring to FIG. 1, in operation 110, the CXL device may obtain statistical information about page access by scanning a PTE related to a page table in a memory. The CXL device may obtain an access count of each page by monitoring an access bit of each page included in the PTE. The access count may be at least a portion of the statistical information.

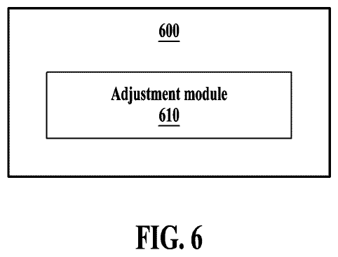

A host device (e.g., the host device 330 of FIG. 3 or a host device 600 of FIG. 6) may transmit a scan frequency related to page access to the CXL device and the CXL device may receive the scan frequency related to page access from the host device. The host device and the CXL device may be connected via CXL and the CXL may refer to an interface for connecting the host device to the CXL device. The host device may be a device for controlling and managing resources of the entire system by transmitting or receiving data to or from the CXL device. The CXL device may scan a PTE according to the scan frequency received from the host device. The CXL device may obtain an access count of each page by monitoring an access bit of each page included in the PTE based on the scan frequency related to the page access.

The CXL device of one or more embodiments may reduce the CPU overhead of the host device by performing frequent PTE scanning. The CXL device of one or more embodiments may improve the accuracy of classification of pages in the PTE into hot pages or cold pages by more frequently performing PTE scanning as the scan frequency is controlled.

In operation 120, the CXL device may classify a page in the PTE as a hot page or a cold page based on the statistical information. The CXL device may obtain a first threshold value to classify a hot page and a cold page. The first threshold value may be, for example, a preset value or a value obtained from the host device. The CXL device of one or more embodiments may more efficiently perform classification of pages according to the first threshold value by obtaining the first threshold value. The CXL device may classify a page as a hot page or a cold page based on the first threshold value and the access count of the page. The CXL device may classify a page as a hot page or a cold page by comparing the first threshold value with the access count of the page, which is at least a portion of the statistical information about the page access. For example, the CXL device may classify a page of which an access count is greater than or equal to the first threshold value as a hot page and may classify a page of which an access count is less than the first threshold value as a cold page.

In operation 130, the CXL device may generate a page list including a classified hot page or a classified cold page. The page list may be used to adjust an LRU list. The page in the LRU list may be adjusted or managed by the LRU algorithm and may be newly sorted.

In response to classifying the page as a hot page or a cold page according to the access count and the first threshold value, the CXL device may generate an initial page list in which the classified hot page or the classified cold page is not sorted. The host device may transmit, to the CXL device, a sort frequency indicating how frequently the page list is sorted according to the LRU algorithm and the CXL device may receive the sort frequency from the host device. The CXL device may generate a page list in a sorted state by sorting the initial page list according to the sort frequency. The CXL device may sort the initial page list according to the sort frequency based on the LRU algorithm. The host device of one or more embodiments may enable more reasonable usage of resources for the system by controlling the sort frequency based on the LRU algorithm.

The CXL device may generate the page list in the sorted state by sorting the classified hot page or the classified cold page according to the size of the access count of the page. The CXL device may obtain (e.g., generate) a page list that is finally sorted by sorting the pages in order of hotness to coldness or in order of large to small (e.g., largest to smallest) access count of the pages.

The statistical information about the page access may include information about at least one of a PTE base address, a PTE offset, an access count of a page, and hot/cold classification flag. In response to obtaining the access count of the page in operation 110, the CXL device may modify or update an access count value of the page included in the statistical information about the page access to an obtained page access value. A data structure of the statistical information about the page access may be shown as Table 1 below, for example.

TABLE 1

| PTE base | | | |
|---|---|---|---|
| address | PTE offset | Access count | Hot/Cold |
| 0xXXXX | 0xXXXX | 5 | Cold |
| | | | (default) |
| . . . | . . . | . . . | . . . |

In Table 1, the CXL device may set a page to a cold page as default before determining whether the page is a hot page or a cold page. Table 1 is only an example and the scope of the embodiment is not limited thereto. In response to determining the page to be a hot page or a cold page based on the first threshold value and the access count of the page in operation 120, the CXL device may set a hot/cold classification flag included in the statistical information about the page access to hot or cold as previous setting or may update the hot/cold classification flag to a value that is different from the previous setting. An example of the updated hot/cold classification flag may be shown as Table 2 below, for example.

TABLE 2

| PTE base | | | |
|---|---|---|---|
| address | PTE offset | Access count | Hot/Cold |
| 0xXXXX | 0xXXXX | 5 | Hot |
| | | | (updated value) |
| . . . | . . . | . . . | . . . |

Each row of the page list may indicate information about one page or a series of pages and the CXL device may obtain the initial page list by classifying a page of the page list as a hot page or a cold page. The initial page list may be a page list in an unsorted state. The example of the initial page list may be shown as Table 3 below, for example.

TABLE 3

| PTE base | | | |
|---|---|---|---|
| address | PTE offset | Access count | Hot/Cold |
| 0xXXXX | 0xXXXX | 6 | Hot |
| 0xXXXX | 0xXXXX | 4 | Hot |
| 0xXXXX | 0xXXXX | 5 | Hot |
| . . . | . . . | . . . | . . . |
| 0xXXXX | 0xXXXX | 1 | Cold |
| 0xXXXX | 0xXXXX | 3 | Cold |
| 0xXXXX | 0xXXXX | 2 | Cold |
| . . . | . . . | . . . | . . . |

The CXL device may generate the page list in the sorted state by sorting the classified hot page or the classified cold page according to the size of the access count of the page. The page list in the sorted state may be a complete page list. The CXL device may sort a page of the initial page list according to a level of hot or cold. An example of the page list in the sorted state may be shown as Table 4 below, for example.

TABLE 4

| PTE base | | | |
|---|---|---|---|
| address | PTE offset | Access count | Hot/Cold |
| 0xXXXX | 0xXXXX | 6 | Hot |
| 0xXXXX | 0xXXXX | 5 | Hot |
| 0xXXXX | 0xXXXX | 4 | Hot |
| . . . | . . . | . . . | . . . |
| 0xXXXX | 0xXXXX | 1 | Cold |
| 0xXXXX | 0xXXXX | 2 | Cold |
| 0xXXXX | 0xXXXX | 3 | Cold |
| . . . | . . . | . . . | . . . |

The sort order of Table 4 is an example and the scope of the embodiment is not limited thereto. The page list may be a list including a plurality of hot pages and a plurality of cold pages. Alternatively, the page list may be two lists, which are a hot page list including a plurality of hot pages and a cold page list including a plurality of cold pages. The page list may be sorted based on the access count of the page.

In operation 140, the CXL device may transmit the page list to the host device. The page list transmitted to the host device may be used to adjust an LRU list by the host device.

The CXL device may transmit the page list in the sorted state to the host device or may transmit some pages in the page list in the sorted state to the host device. The CXL device may extract a hot page of which an access count is greater than or equal to a second threshold value from hot pages included in the generated page list and a cold page of which an access count is less than the second threshold value from cold pages included in the generated page list. The CXL device may transmit a page list including only the extracted hot page and the extracted cold page to the host device. For example, the second threshold value may be a value of an access count corresponding to the top 10% or bottom 10% of a total access count in the page list in the sorted state. The CXL device may obtain a hot page of which an access count is included in the top 10% among the hot pages included in the generated page list and a cold page of which an access count is included in the bottom 10% among the cold pages included in the generated page list. The CXL device may transmit the obtained hot page included in the top 10% and the obtained cold page included in the bottom 10% to the host device. In another example, the CXL device may extract a hot page of which an access count is greater than or equal to the second threshold value from hot pages included in the generated page list and a cold page of which an access count is less than or equal to a third threshold value from cold pages included in the generated page list, where the third threshold value is less than the second threshold value. In the transmitted page list, an absolute order of a hottest page and a coldest page in the system may be ensured by adjusting some hot pages to a head of an active LRU list and some cold pages to a tail of an inactive LRU list by the host device. However, this is an example and the scope of the embodiment is not limited thereto.

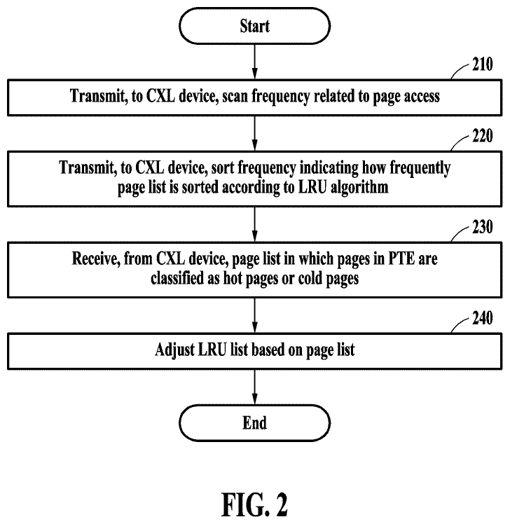

FIG. 2 is a flowchart of a method of managing a page list executed by a host device according to one or more embodiments. Operations of the method of managing a page list described with reference to FIG. 2 may be performed by an electronic device such as a host device (e.g., a host device 330 of FIG. 3 or a host device 600 of FIG. 6) described herein. Operations 210 to 240 to be described hereinafter may be performed sequentially in the order and manner as shown and described below with reference to FIG. 2, but two or more of the operations may be performed simultaneously or in parallel, the order of one or more of the operations may be changed, one or more of the operations may be omitted, and other operations may be additionally performed without departing from the spirit and scope of the example embodiments described herein.

Referring to FIG. 2, in operation 210, a host device may transmit a scan frequency related to page access to a CXL device (e.g., the CXL device 300 of FIG. 3 or the CXL device 500 of FIG. 5). The CXL device that receives the scan frequency may obtain statistical information about the page access by scanning a PTE related to a page table and may obtain an access count based on the scan frequency. The statistical information may include an access count of a page and the access count of the page may be obtained by monitoring an access bit of the page based on the scan frequency by the CXL device.

In operation 220, the host device may transmit, to the CXL device, a sort frequency indicating how frequently a page list is sorted according to the LRU algorithm. The CXL device that receives the sort frequency may generate a page list and the page list may be generated by sorting an initial page list according to the sort frequency, wherein the initial page list includes a classified hot page or a classified cold page in an unsorted state. The page list may include a hot page of which an access count of the page is greater than or equal to the second threshold value and a cold page of which an access count of the page is less than the second threshold value.

In operation 230, the host device may receive, from the CXL device, the page list in which the pages in the PTE are classified as hot pages or cold pages. In response to the page list used by the host device being stored in a storage, such as a CXL memory, the page list may be transmitted to a host processor (e.g., a CPU) of the host device. The page list transmitted to the host device may be a page list in which the initial page list generated based on the first threshold value and the access count of the page is sorted according to the size of the access count of the page.

The page list that the host device receives may be a page list in the sorted state or a page list including some pages in the page list in the sorted state. When the host device receives a complete page list (or the page list in the sorted state), the host device may extract a hot page of which an access count is greater than or equal to the second threshold value from hot pages included in the received complete page list and a cold page of which an access count is less than the second threshold value from cold pages included in the complete page list.

In operation 240, the host device may adjust the LRU list based on the page list. The host device may dispose a hot page of which the access count of the page is greater than or equal to the second threshold value on the head of an active LRU list in an LRU list. The host device may dispose a cold page of which the access count of the page is less than the second threshold value on the tail of an inactive LRU list in the LRU list. For example, the host device may adjust the top 10% hot pages of the hot pages and the bottom 10% cold pages of the cold pages to the head of the active LRU list and the tail of the inactive LRU list, respectively.

FIG. 3 is a diagram illustrating an architecture of a method of managing a page list according to one or more embodiments.

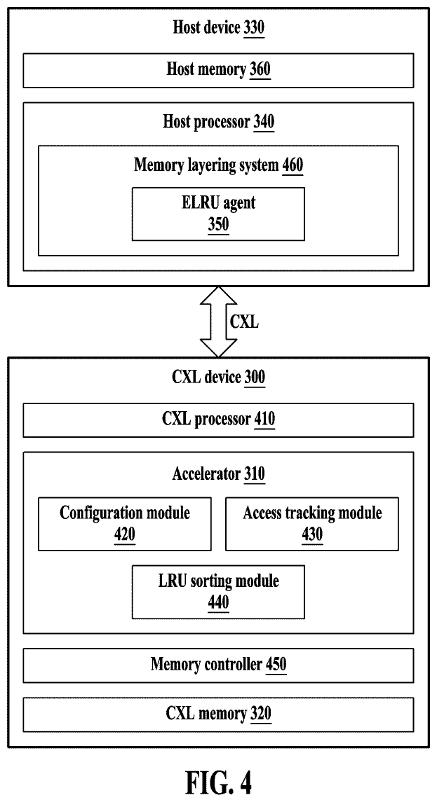

Referring to FIG. 3, a CXL device 300 (e.g., the CXL device 300 of FIG. 4 and/or the CXL device 500 of FIG. 5) may include an accelerator 310 and a CXL memory 320. For example, the accelerator 310 may be a processing near memory (PNM) accelerator for improving the accessibility of the memory. The accelerator 310 may scan a PTE and may sort a page list.

In association with PTE scanning, the accelerator 310 may scan the PTE in parallel and may reset a PTE stored in a host memory 360 in a host device 330 (e.g., the host device 330 of FIG. 4 and/or the host device 600 of FIG. 6). In response to updating statistical information about page access, the accelerator 310 may generate a page list including a classified hot page or a classified cold page and may store the generated page list in the CXL memory 320. The CXL memory 320 may store statistical information 322 about page access.

In association with page list sorting, the accelerator 310 may sort the classified hot page or the classified cold page according to the size of the page access count and may generate a page list in a sorted state. The accelerator 310 may further include a configuration module (not shown in FIG. 3) and the configuration module may include an interface to obtain a scan frequency related to page access and a sort frequency according to the LRU algorithm and an interface to obtain the first threshold value to classify hot pages and cold pages.

The host device 330 may include a host processor 340 (e.g., one or more processors) and a host memory 360 (e.g., one or more memories). For example, the host processor 340 may be or include a CPU and the host memory 360 may be or include dynamic random access memory (DRAM). The host memory 360 may store a page list 362 received from the CXL device 300 and an LRU list 365 adjusted by the host device 330.

The host processor 340 may include an enhanced LRU (ELRU) agent 350 and the ELRU agent 350 may adjust the LRU list 364. The ELRU agent 350 may adjust the LRU list 364 using the page list 362 in the sorted state, wherein the page list 362 is transmitted from the CXL device 300 and is stored in the host memory 360.

FIG. 4 is a diagram illustrating a framework between a CXL device and a host device according to one or more embodiments. Referring to FIG. 4, an interaction between the CXL device 300 (e.g., the CXL device 500 of FIG. 5) and the host device 330 (e.g., the host device 600 of FIG. 6) is described. The page list management device described herein may include the CXL device 300 and the host device 330.

The CXL device 300 may include an accelerator 310, the CXL memory 320, a CXL processor 410, and a memory controller 450. The accelerator 310 may include a configuration module 420, an access tracking module 430, and an LRU sorting module (or a page sorting module) 440. Some of the components included in the CXL device 300 and the host device 330 may be omitted, merged, and/or added.

The CXL processor 410 may control the configuration module 420, the access tracking module 430, and the LRU sorting module 440 included in the accelerator 310 to perform respective operations. Alternatively, the CXL processor 410 may include the accelerator 310 as a component and may control the CXL processor 410 to perform operations performed by the accelerator 310. The memory controller 450 may manage and control the CXL memory 320. When the operations performed by the accelerator 310 include a read or write request to the CXL memory 320, the memory controller 450 may control processing data stored in the CXL memory 320 with respect to operations to access the CXL memory 320.

The configuration module 420 may be used to set resources required for page access tracking and sorting an LRU list in the CXL device 300. The configuration module 420 may provide two configuration interfaces and one interface may be used to receive and transmit a scan frequency related to page access and a sort frequency according to the LRU algorithm. The other interface of the configuration module 420 may be used to receive and transmit a first threshold value to classify a page as a hot page or a cold page. For example, the configuration module 420 may receive the scan frequency related to page access, the sort frequency of the page list according to the LRU algorithm, and the first threshold value from the host processor 340 of the host device 330. The configuration module 420 may control the access tracking module 430 to regularly scan a PTE based on the scan frequency related to page access and classify hot pages and cold pages based on the first threshold value. The configuration module 420 may control the LRU sorting module 440 to regularly sort a page list generated by the access tracking module 430 based on the sort frequency according to the LRU algorithm. The two configuration interfaces of the configuration module 420 are an example and the type and number of interfaces are not limited thereto.

The access tracking module 430 may regularly monitor an access bit (e.g., PAGE_BIT_ACCESSED of a PTE) of a page to collect the statistical information about the page access. The access tracking module 430 may obtain an access count of the page by monitoring the access bit of the page. The access tracking module 430 may perform a parallel scan of a PTE and may reset a PTE stored in the host memory 360. A data structure of the statistical information about the page access may be the same as the example of Table 1 described above. A function of collecting the statistical information about the page access may include a function to read or delete information about the page access in a PTE in parallel through a plurality of task commands.

As the PTE is regularly scanned, the statistical information about the page access may be updated. A page in the PTE may be classified as a hot page or a cold page based on the updated statistical information. The access tracking module 430 may generate a page list including the classified hot page or the classified cold page. The page list generated by the access tracking module 430 may be an initial page list in which the classified hot page or the classified cold page is not sorted. The access tracking module 430 may generate a page list as the examples of Table 3 described above by determining a page to be a hot page or a cold page. The page list generated by the access tracking module 430 may be provided to the LRU sorting module 440.

The LRU sorting module 440 may sort the page list provided by the access tracking module 430. The LRU sorting module 440 may obtain the page list from the access tracking module 430 first and then may sort the obtained page list from the access tracking unit 430 based on the sort frequency obtained from the configuration module 420. The LRU sorting module 440 may generate the page list in the sorted state by obtaining an initial page list from the access tracking module 430 and sorting the initial page list based on the sort frequency. For example, the LRU sorting module 440 may obtain the page list in the sorted state as the example of Table 4 described above by sorting the initial page list as the example of Table 3 described above. The LRU sorting module 440 may transmit the page list in the sorted state to the ELRU agent 350 or may transmit some pages in the page list in the sorted state to the ELRU agent 350. The LRU sorting module 440 may extract a hot page of which an access count is greater than or equal to the second threshold value from hot pages included in the page list in the sorted state and a cold page of which an access count is less than the second threshold value from cold pages included in the page list in the sorted state. The LRU sorting module 440 may transmit the extracted hot page and the extracted cold page to the ELRU agent 350.

The host device 330 may include the host processor 340 and host memory 360 and the host processor 340 may be involved in a memory layering system 460 of the host device 330 to perform memory layering. The memory layering may be performed by the ELRU agent 350 in the host processor 340. The ELRU agent 350 may receive the page list in the sorted state from the LRU sorting module 440. The ELRU agent 350 may extract a hot page of which an access count is greater than or equal to the second threshold value from hot pages included in the received page list and a cold page of which an access count is less than the second threshold value from cold pages. The ELRU agent 350 may arrange the hot page, of which the access count of the extracted page is greater than or equal to the second threshold value, on the head of the active LRU list in the LRU list. The ELRU agent 350 may arrange the cold page, of which the access count of the extracted page is less than the second threshold value, on the tail of the inactive LRU list in the LRU list. For example, the ELRU agent 350 may extract the top 10% of the hot pages and the bottom 10% of the cold pages and may adjust the top 10% of hot pages and the bottom 10% of cold pages to the head of the active LRU list and the tail of the inactive LRU list, respectively.

In a framework of one or more embodiments between the CXL device 300 and the host device 330 communicating based on CXL, frequent scanning of a PTE performed by the CXL device 300 may improve the accuracy of page classification. Alternatively or additionally, this frequent scanning of one or more embodiments of the PTE may allow a Linux kernel that performs memory layering in the host device 330 to determine more accurate page retrieval and page arrangement.

FIG. 5 is a block diagram illustrating a CXL device included in a page list management device according to one or more embodiments.

A CXL device 500 (e.g., the CXL device 300 of FIG. 3) may include an access tracking module 510 (e.g., the access tracking module 430 of FIG. 4) and an LRU sorting module 520 (e.g., the LRU sorting module 440 of FIG. 4). Each module of the CXL device 500 may be implemented as one or more modules and the name of the module may vary depending on the type of the module. In various embodiments, some modules of the CXL device 500 may be omitted or an additional module may be included. In addition, the module may be combined to form a single entity and the combined single entity may identically perform functions of each module before being combined.

The access tracking module 510 may obtain statistical information about page access by scanning a PTE related to a page table. The access tracking module 510 may regularly monitor an access bit of a page to collect the statistical information about the page access and may obtain an access count of the page by monitoring the access bit of the page. The access tracking module 510 may generate a page list in which the page in the PTE is classified as a hot page or a cold page based on the statistical information about the page access. The page list may be used to adjust the LRU list.

The LRU sorting module 520 may sort the page list. The LRU sorting module 520 may sort an initial page list in an unsorted state based on the size of the access count of the page included in the statistical information about the page access. The LRU sorting module 520 may extract a hot page of which an access count is greater than or equal to the second threshold value from hot pages included in the page list in the sorted state and a cold page of which an access count is less than the second threshold value from cold pages included in the page list in the sorted state. The extracted hot page and the extracted cold page may be used to adjust the head of the active LRU list and the tail of the inactive LRU list in the LRU list.

The CXL device 500 may further include a configuration module (e.g., the configuration module 420). The configuration module may receive a scan frequency with respect to the page access. The configuration module may obtain the first threshold value to classify a page as a hot page or a cold page. The obtained first threshold value may be provided to the access tracking module 510. The first threshold value may be used to generate a page list in which a page, of which an access count of the page is greater than or equal to the first threshold value, is classified as a hot page and a page of which an access count of the page is less than the first threshold value, is classified as a cold page. The configuration module may obtain a sort frequency indicating how frequently the page list is sorted according to the LRU algorithm. The obtained sort frequency may be provided to the LRU sorting module 520. The initial page list in which the classified hot page or the classified cold page is not sorted may be changed to a page list in a sorted state by being sorted based on the corresponding sort frequency.

FIG. 6 is a block diagram illustrating a host device included in a page list management device according to one or more embodiments. Referring to FIG. 6, a host device 600 (e.g., the host device 330 of FIG. 3) may include an adjustment module 610 (e.g., the ELRU agent 350 of FIG. 3). Each module of the host device 600 may be implemented as one or more modules and the name of the module may vary depending on the type of the module. In various embodiments, the host device 600 may include an additional module.

The adjustment module 610 may adjust a hot page, of which an access count is greater than or equal to the second threshold value, in a transmitted page list to the head of an active LRU list in an LRU list and may adjust a cold page, of which an access count of the page is less than the second threshold value, to the tail of an inactive LRU list in the LRU list. The page list may include a hot page of which an access count is greater than or equal to the second threshold value and a cold page of which an access count of the page is less than the second threshold value. For example, the adjustment module 610 may arrange the top 10% of the hot pages and the bottom 10% of the cold pages on the head of the active LRU list and the tail of the inactive LRU list, respectively.

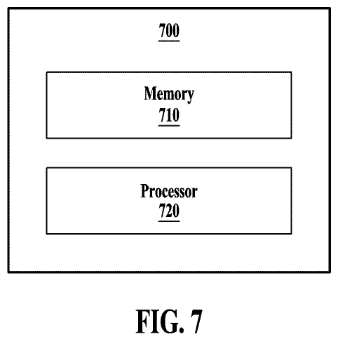

FIG. 7 is a block diagram illustrating an electronic device according to a one or more embodiments. Referring to FIG. 7, an electronic device 700 may include a memory 710 (e.g., one or more memories) and a processor 720 (e.g., one or more processors). The memory 710 may store instructions and when the instructions are executed by the processor 720, the electronic device 700 may execute the method of managing a page list described herein. For example, the memory 710 may be or include a non-transitory computer-readable storage medium storing code that, when executed by the processor 720, configure the processor 720 to perform any one, any combination, or all of the operations and/or methods described herein with reference to FIGS. 1-6. A device for page list management including the CXL device (e.g., the CXL device 300 of FIGS. 3 and 4 and the CXL device 500 of FIG. 5) and the host device (e.g., the host device 330 of FIGS. 3 and 4 and the host device 600 of FIG. 6) described with reference to FIGS. 3 to 6 may be implemented by the electronic device 700.

The electronic device 700 may be a personal computer (PC), a tablet device, a personal digital assistant (PDA), a smartphone, and/or any other device for executing the instructions. The electronic device 700 may not need to be a single electronic device and may include a device or assembly of circuits capable of individually or jointly executing the instructions. The electronic device 700 may also be a part of an integrated control system or a system administrator and may be configured as a portable electronic device for interfacing locally and/or remotely. The electronic device 700 may include a video display (e.g., a liquid crystal display) and a user interaction interface (e.g., a keyboard, a mouse, a touch input device, etc.). All components of the electronic device 700 may be interconnected via a bus and/or a network.

The memory 710 may store information necessary for the processor 720 to perform a processing operation. For example, the memory 710 may store instructions to be executed by the processor 720 and may store related information while a software or a program is executed in the electronic device 700. The memory 710 may include a volatile memory such as a RAM, a DRAM, and/or a non-volatile memory known in the art such as a flash memory. For example, the memory 710 may be integrated with the processor 720 by arranging RAM or flash memory in an IC microprocessor. In addition, the memory 710 may include an independent device, such as an external disk drive, a storage array, and/or other storage devices used by a database system. The memory 710 and the processor 720 may be operatively integrated or may allow the processor 720 to read a file stored in the memory 710 by communicating with each other via an I/O port or network connection.

The processor 720 may perform instructions stored in the memory 710. The processor 720 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), and/or a combination thereof.

According to the method and device for page list management described herein, the method and device of one or more embodiments may implement more accurate page retrieval and page arrangement by improving the accuracy of classification of hot pages and cold pages with low CPU overhead by frequently scanning a PTE and sorting a page list in the CXL device. The method and device of one or more embodiments may allow the CXL device to use resources for the system more reasonably by controlling a scan frequency of page access. In addition, the method and device of one or more embodiments may improve the accuracy of page classification by helping page classification according to the environment by controlling a first threshold value to classify hot pages and cold pages. The method and device of one or more embodiments may enable reasonable usage of resources for the system by controlling a sort frequency according to an LRU algorithm and may ensure an absolute order of the hottest page and the coldest page in the system by adjusting an LRU list.

The CXL devices, accelerators, CXL memories, host devices, host processors, host memories, memory layering systems, CXL processors, configuration modules, access tracking modules, LRU sorting modules, memory controllers, adjustment modules, electronic devices, memories, processors, CXL device 300, accelerator 310, CXL memory 320, host device 330, host processor 340, host memory 360, memory layering system 460, CXL processor 410, configuration module 420, access tracking module 430, LRU sorting module 440, memory controller 450, CXL device 500, access tracking module 510, LRU sorting module 520, host device 600, adjustment module 610, electronic device 700, memory 710, and processor 720 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method comprising:
obtaining statistical information about page access by scanning a page table entry related to a page table;
classifying a page in the page table entry as a hot page or a cold page based on the statistical information;
generating a page list comprising the classified hot page or the classified cold page; and
transmitting the page list to a host device,
wherein the page list is used to adjust a least recently used (LRU) list.

2. The method of claim 1, wherein
the obtaining of the statistical information comprises:
receiving a scan frequency related to the page access from the host device; and
obtaining an access count of the page by monitoring an access bit of the page based on the scan frequency, and
the access count is at least a portion of the statistical information.

3. The method of claim 2, wherein the classifying of the page as the hot page or the cold page comprises:
obtaining a threshold value to classify the page as either one of the hot page and the cold page; and
classifying the page as the hot page or the cold page based on the access count of the page and the threshold value.

4. The method of claim 3, wherein the classifying of the page as the hot page or the cold page comprises classifying a page of which an access count of the page is greater than or equal to the threshold value as the hot page and classifying a page of which an access count of the page is less than the threshold value as the cold page.

5. The method of claim 2, wherein the generating of the page list comprises:
generating an initial page list in which the classified hot page or the classified cold page is not sorted;
receiving, from the host device, a sort frequency indicating how frequently the initial page list is to be sorted according to an LRU algorithm; and
generating the page list in a sorted state by sorting the initial page list based on the sort frequency.

6. The method of claim 5, wherein the generating of the page list in the sorted state by sorting the initial page list comprises generating the page list in the sorted state by sorting the classified hot page or the classified cold page according to a size of the access count of the page.

7. The method of claim 1, wherein the transmitting of the page list to the host device comprises:
extracting a hot page of which an access count is greater than or equal to a threshold value from one or more hot pages included in the generated page list and a cold page of which an access count is less than the threshold value from one or more cold pages included in the generated page list; and
transmitting the page list comprising the extracted hot page and the extracted cold page to the host device.

8. The method of claim 1, further comprising:
receiving, from a compute express link (CXL) device, the page list; and
adjusting the LRU list based on the page list.

9. A method comprising:
receiving, from a compute express link (CXL) device, a page list in which a page in a page table entry is classified as a hot page or a cold page; and
adjusting a least recently used (LRU) list based on the page list,
wherein the page list is generated based on statistical information about page access obtained by scanning the page table entry related to a page table.

10. The method of claim 9, further comprising transmitting a scan frequency related to the page access to the CXL device.

11. The method of claim 10, wherein
the statistical information comprises an access count of the page, and
the access count of the page is obtained by monitoring an access bit of the page based on the scan frequency by the CXL device.

12. The method of claim 9, further comprising transmitting, to the CXL device, a sort frequency indicating how frequently a page list is sorted according to an LRU algorithm,
wherein the page list is generated by sorting an initial page list comprising the classified hot page or the classified cold page in an unsorted state, based on the sort frequency.

13. The method of claim 9, wherein the page list comprises a hot page of which an access count of the page is greater than or equal to a threshold value and a cold page of which an access count of the page is less than the threshold value.

14. The method of claim 13, wherein the adjusting of the LRU list comprises:
arranging the hot page of which the access count of the page is greater than or equal to the threshold value on a head of an active LRU list in the LRU list; and
arranging the cold page of which the access count of the page is less than the threshold value on a tail of an inactive LRU list in the LRU list.

15. A device for managing a page list, the device comprising:
a compute express link (CXL) device comprising a CXL processor and a CXL memory; and
a host device comprising a host processor and a host memory,
wherein the CXL device is configured to:
obtain statistical information about page access by scanning a page table entry related to a page table;
classify a page in the page table entry as a hot page or a cold page based on the statistical information;
generate a page list comprising the classified hot page or the classified cold page; and
transmit the page list to a host device, and
wherein the page list is used to adjust a least recently used (LRU) list.

16. The device of claim 15, wherein
the CXL device is configured to:
receive a scan frequency related to the page access from the host device; and
obtain an access count of the page by monitoring an access bit of the page based on the scan frequency, and
the access count is at least a portion of the statistical information.

17. The device of claim 15, wherein the CXL device is configured to:
obtain a threshold value to classify the page as either one of the hot page and the cold page; and
classify the page as the hot page or the cold page based on the access count of the page and the threshold value.

18. The device of claim 15, wherein the CXL device is configured to:
generate an initial page list in which the classified hot page or the classified cold page is not sorted;
receive, from the host device, a sort frequency indicating how frequently the initial page list is to be sorted according to an LRU algorithm; and
generate the page list in a sorted state by sorting the initial page list based on the sort frequency.

19. The device of claim 15, wherein the host device is configured to:
receive the page list in which a page in the page table entry is classified as the hot page or the cold page from the CXL device; and
adjust the LRU list based on the page list.

20. The device of claim 19, wherein the host device is configured to:
arrange a hot page of which an access count of the page is greater than or equal to a threshold value on a head of an active LRU list in the LRU list; and
arrange a cold page of which an access count of the page is less than the second value on a tail of an inactive LRU list in the LRU list.
